(19) United States
(12) Patent Application Publication
(10) Pub. No.: US 2022/0382513 A1
(43) Pub. Date: Dec. 1, 2022

(54) DISPLAY SYSTEM, DISPLAY DEVICE, AND CONTROL METHOD FOR DISPLAY DEVICE

(71) Applicant: SEIKO EPSON CORPORATION, Tokyo (JP)

(72) Inventors: Motoki UEDA, Azumino-shi (JP); Toshiki FUJIMORI, Chino-shi (JP)

(21) Appl. No.: 17/826,244

(22) Filed: May 27, 2022

(30) Foreign Application Priority Data
May 27, 2021 (JP) 2021-089063

(51) Int. Cl. G06F 3/16; G06F 3/0484; G10L 15/00

(52) U.S. Cl. CPC G06F 3/167; G06F 3/0484; G10L 15/005; H04N 9/31

(57) ABSTRACT

A display system includes a microphone, a voice processing device, and a display device including at least one processor. The microphone collects a voice corresponding to a command and generates voice data representing the voice. The voice processing device analyzes the voice data to generate a language identifier indicating a type of a language of the voice and command data representing the command, and outputs the language identifier and the command data. The at least one processor executes displaying a user interface screen describing information using a display language, which is one language of a plurality of types of languages, receiving the language identifier and the command data outputted from the voice processing device, comparing the type indicated by the language identifier with the type of the display language, and changing the display language to the language of the type indicated by the language identifier when the type indicated by the language identifier and the type of the display language differ from each other.

The present application is based on, and claims priority from JP Application Serial Number 2021-089063, filed May 27, 2021, the disclosure of which is hereby incorporated by reference herein in its entirety.

### BACKGROUND

### 1. Technical Field

The present disclosure relates to a display system, a display device, and a control method for a display device.

### 2. Related Art

A technique of operating various electronic devices by voice is in widespread use. For example, JP-A-2019-82994 discloses a smart speaker having a multilingual interface for voice input in a plurality of types of languages or dialects.

if a projector that is operable by voice can recognize a plurality of types of languages, for example, a language used to describe information on an OSD (on-screen display) needs to be set on a menu screen of the OSD. Hereinafter, a language used to describe information on a user interface screen such as an OSD may be referred to as a display language. The projector that can recognize a plurality of types of languages has a problem in that, if an instruction to display a user interface screen is given by a voice operation in a circumstance where a display language is not set corresponding to the language used for the voice operation, a user interface screen describing various kinds of information in a display language that is different from the language for the voice operation is displayed.

### SUMMARY

According to an aspect of the present disclosure, a display system includes a display device, a microphone, and a voice processing device. The display device displays a user interface screen describing information using a display language, which is ore language of a plurality of types of languages, and also executes processing corresponding to a given command. The microphone collects a voice corresponding to the command and generates voice data representing the collected voice. The voice processing device analyzes the voice data to generate a language identifier indicating a type of a language of the voice represented by the voice data and command data representing the command, and outputs the language identifier and the command data thus generated. The display device includes a processing device, and a communication device for communicating with the voice processing device. The processing device executes receiving processing and first change processing, described below. The receiving processing is the processing of receiving the language identifier and the command data outputted from the voice processing device, using the communication device. The first change processing is the processing of comparing the type indicated by the language identifier received in the receiving processing with the type of the display language, and changing the display language to the language of the type indicated by the language identifier when the type indicated by the language identifier and the type of the display language differ from each other.

According to another aspect of the present disclosure, a display device displays a user interface screen describing information using a display language, which is one language of a plurality of types of languages, and also executes processing corresponding to a given command. The display device includes the communication device and the processing device described above.

According to still another aspect of the present disclosure, a control method for a display device is provided. The display device displays a user interface screen describing information using a display language, which is one language of a plurality of types of languages, and also executes processing corresponding to a given command. The control method includes generation processing, described below, and the receiving processing and the first change processing, described above. The generation processing is the processing of collecting a voice corresponding to a command with a microphone and thus generating voice data representing the voice.

### BRIEF DESCRIPTION OF THE DRAWINGS

FIG. 1 shows an example of the configuration of a display system 1 according to an embodiment of the present disclosure.

FIG. 2 shows an example of the configuration of a display device 10 included in the display system 1.

FIG. 3 is a flowchart showing the flow of a control method for the display device 10.

### DESCRIPTION OF EXEMPLARY EMBODIMENTS

In an embodiment described below, various technically preferable limitations are described. However, the present disclosure is not limited to the embodiment described below.

### 1. Embodiment

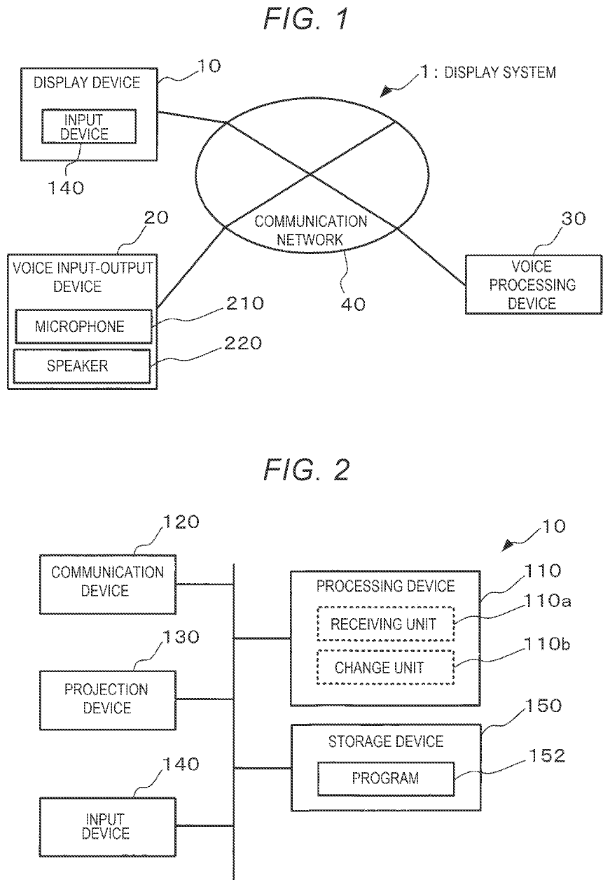

FIG. 1 shows an example of a display system 1 according to an embodiment of the present disclosure. The display system 1 includes a display device 10, a voice input-output device 20, and a voice processing device 30. As shown in FIG. 1, the display device 10, the voice input-output device 20, and the voice processing device 30 are connected to a communication network 10. The communication network 40 is the internet, for example. The connection between the communication network 40 and each of the display device 10, the voice input-output device 20, and the voice processing device 30 may be wired connection or wireless connection.

The display device 10 displays an image representing image data supplied from an image supply device, not illustrated, or an image of a user interface screen for causing a user to refer to and update various settings when using the display device 10. For example, when the display device 10 is connected to the communication network 40 via a LAN (local area network), a personal computer connected to the LAN may be employed as a specific example of the image supply device. In the description below, the image displayed by the display device 10 may be referred to as a display target image. The display device 10 in this embodiment displays a user interface screen describing information, using a display language, which is one language set in a language setting menu or the like, from among a plurality of predetermined types of languages. As a specific example of the plurality of types of languages, Japanese and English may be employed. As a specific example of the user interface screen, a menu screen displayed by an COD for changing various kinds of setting information prescribing operations of the display device 10 may be employed.

The display device 10 in this embodiment is a projector, for example. The display device 10 projects a display target image onto a projection surface such as a projection screen and thus displays the display target image. In FIG. 1, the projection surface is not illustrated. The display device 10 in this embodiment has an input device 140 having an operating element such as a numeric keypad. The user of the display device 10 can input various commands by input operations to the input device 140. The display device 10 executes processing corresponding to a command inputted by an input operation to the input device 140.

As a specific example of the command that can be inputted by an input operation to the input device 140, a command giving an instruction to change the display language, a command giving an instruction to display a user interface screen, a command designating the supply source of mage data representing a display image, or the like, may be employed. For example, when the command giving an instruction to display a user interface screen is inputted by an input operation to the input device 140, the display device 10 displays a user interface screen describing information in the display language.

In this embodiment, the voice input-output device is installed near the display device 10. The voice input-output device 20 is a smartphone, for example. The voice input-output device 20 includes a microphone 210 and a speaker 220. The microphone 210 collects a voice for carrying out a voice operation of the display device 10, that is, a voice corresponding to a command giving an instruction to execute various operations, and generates voice data representing the collected voice. The voice corresponding to the command may be a voice reading the command aloud or a voice representing the content of processing to be instructed by the command, such as “XXX, display the user interface screen” or “XXX, switch the supply source of the image to the LAN source”. The “XXX” part is a predetermined wake word indicating that it is a voice corresponding to a command. As only a voice starting with the wake word is defined as a target sound to be collected by the voice input-output device 20, an operation error of the display device 10 due to the collection of a voice unrelated to a voice operation, such as “we will now start the conference”, can be avoided.

In this embodiment, the user of the display device 10 utters a voice for carrying out a voice operation of the display device 10, toward the voice input-output device 20. The voice of the user uttered toward the voice input-output device 20 is collected by the microphone 210. The voice input-output device 20 transmits voice data generated by the microphone 210 to the voice processing device 30. Meanwhile, when receiving voice data from the voice processing device 30 via the communication network 40, the voice input-output device 20 causes the speaker 220 to release a voice represented by the voice data.

The voice processing device 30 analyzes the voice data received from the voice input-output device 20 via the communication network 40. By analyzing the received voice data, the voice processing device 30 generates a language identifier indicating the type of the language of the voice represented by the voice data. By analyzing the received voice data, the voice processing device 30 also generates character string data representing a command corresponding to the voice represented by the voice data. In the description below, a character string data representing a command is referred to as command data. For the analysis of the voice data, a suitable existing technique may be used. The voice processing device 30 may be implemented by a single computer or by a plurality of computers cooperating with each other.

The voice processing device 30 transmits the language identifier and the command data generated by analyzing the received voice data, to the display device 10. In this way, voice data representing a voice collected by the microphone 210 of the voice input-output device 20 is provided to the voice processing device 30, and command data representing a command corresponding to the voice is provided from the voice processing device 30 to the display device 10. Thus, a voice operation of the display device 10 is implemented. When receiving an acknowledgement from the display device 10 to the effect that the command data has been received, the voice processing device 30 transmits voice data representing a predetermined response voice to the voice input-output device 20. As a specific example of this response voice, a voice such as “understood” or “input has been accepted” may be employed. As the response voice is released from the speaker of the voice input-output device 20, the user can grasp that the voice instruction has been accepted by the display device 10.

FIG. 2 shows an example of the configuration of the display device 10. As shown in FIG. 2, the display device 10 has a processing device 110, a communication device 120, a projection device 130, and a storage device 150, in addition to the input device 140.

The communication device 120 is connected to the communication network 40 via a communication line such as a LAN cable. The communication device 120 is a device communicating data with another device via the communication network 40. In this embodiment, the another device for the display device 10 is the voice processing device 30 and the image supply device. As a specific example of the communication device 120, a NIC (network interface card) may be employed. The communication device 120 receives data transmitted from the another device via the communication network 40. The communication device 120 passes on the received data to the processing device 110. The communication device 120 also transmits data provided from the processing device 110, to the another device via the communication network 40.

The projection device 130 projects a display target image onto a projection surface, based on an image signal provided from the processing device 110. Although not illustrated in detail in FIG. 2, the projection device 130 includes a projection system including a projection lens, a liquid crystal drive unit, a liquid crystal panel, and a light source unit. The liquid crystal drive unit drives the liquid crystal panel, based on an image signal provided from the processing device 110, and thus draws an image represented by this image signal on the liquid crystal panel. The light source unit includes, for example, a light source such as a halogen lamp or a laser diode. The light from the light source unit is modulated for each pixel in the liquid crystal panel and is projected onto the projection surface by the projection system.

The storage device 150 is a recording medium readable by the processing device 110. The storage device 150 includes a non-volatile memory and a volatile memory, for example. The non-volatile memory is, for example, a ROM (read-only memory), an EPROM (erasable programmable read-only memory), or an EEPROM (electrically erasable programmable read-only memory). The volatile memory is a RAM (random-access memory), for example. In the non-volatile memory of the storage device 150, a program 152 for causing the processing device 110 to execute processing that prominently expresses characteristics of the present disclosure is stored. Although not illustrated in detail in FIG. 2, various kinds of setting information prescribing operations of the display device 10 are stored in the non-volatile memory. The setting information includes correction information representing keystone correction or the like to be performed on the display target image, and a display language identifier indicating the display language. The volatile memory of the storage device 150 is used as a work area by the processing device 110 when executing the program 152.

The processing device 110 includes, for example, a processor such as a CPU (central processing unit), that is, a computer. The processing device 110 may be formed by a single computer or a plurality of computers. The processing device 110 reads out the program 152 from the non-volatile memory to the volatile memory in response to the power of the display device 10 being tuned on, and starts executing the read-out program 152. In FIG. 2, the power of the display device 10 is not illustrated. The processing device 110 operating according to the program 152 copies the setting information stored in the non-volatile memory into the volatile memory and executes various operations according to the copied setting information. For example, the processing device 110 operating according to the program 152 performs keystone correction represented by the correction information onto an image represented by projection image data provided from the image supply device via the communication device 120, and causes the projection device 130 to display the corrected image. Also, the processing device 110 operating according to the program 152 executes processing corresponding to a command inputted by an input operation to the input device 140 or a command represented by command data received by the communication device 120. For example, when an instruction to display a user interface screen is given by an input operation to the input device 140, the processing device 110 displays a user interface screen describing information in the display language indicated by the display language identifier stored in the volatile memory.

The processing device 110 operating according to the program 152 functions as a receiving unit 110a and a change unit 110b shown in FIG. 2. That is, the receiving unit 110a and the change unit 110b in FIG. 2 are software modules implemented by causing the processing device 110 to operate according to the program 152. In FIG. 2, dashed lines indicate that each of the receiving unit 110a and the change unit 110b is a software module. The functions implemented by each of the receiving unit 110a and the change unit 110b are described below.

The receiving unit 110a communicates with the voice processing device 30, using the communication device 120, and thus receives a language identifier and command data transmitted from the voice processing device 30. On receiving the language identifier and the command data, the receiving unit 110a transmits an acknowledgement to the voice processing device 30. The change unit 110b compares the language identifier with the display language identifier stored in the volatile memory. When the language identifier and the display language identifier stored in the volatile memory differ from each other, that is, when the type of the language indicated by the language identifier and the type of the language indicated by the display language identifier stored in the volatile memory differ from each other, the change unit 110b overwrites the display language identifier stored in the volatile memory with the language identifier and thus changes the display language. In this embodiment, the display language identifier stored in the non-volatile memory is not updated. Therefore, in the case where the power of the display device 10 is turned off after the update of the display language identifier by the change unit 110b and subsequently the power of the display device 10 is turned on again, the display language identifier stored in the volatile memory returns to the display language identifier as of before The change by the change unit 110b.

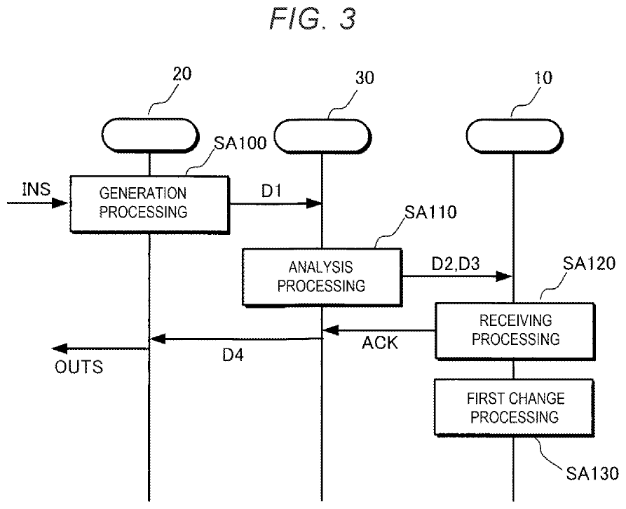

FIG. 3 shows the flow of a control method for the display device 10. As shown in FIG. 3, the control method in this embodiment includes generation processing SA100, analysis processing SA110, receiving processing SA120, and first change processing SA130. The generation processing SA100 is the processing executed by the voice input-output device 20. The analysis processing SA110 is the processing executed by the voice processing device 30. The receiving processing SA120 and the first change processing SA130 are the processing executed by the processing device 110 operating according to the program 152. The content of each of the generation processing SA100, the analysis processing SA110, the receiving processing SA120, and the first change processing SA130 is described below. In the operation example described below, English is set as the display language. That is, a display language identifier indicating English is stored in the volatile memory of the display device 10.

In the generation processing SA100, the voice input-output device 20 collects a voice of the user for a voice operation of the display device 10, using the microphone 210, and thus generates voice data representing the voice for the voice operation. For example, it is assumed that the user of the display device 10 utters a voice INS in Japanese, “XXX, switch the supply source of the image to the LAN source”, toward the voice input-output device 20. The voice input-output device 20 generates voice data D1 representing the voice INS. In the generation processing SA100, the voice input-output device 20 transmits the generated voice data D1 to the voice processing device 30.

In the analysis processing SA110, the voice processing device 30 analyzes the voice data D1 received from the voice input-output device 20 and thus generates a language identifier D2 and command data D3. The voice INS represented by the voice data D1 is a voice in Japanese. Therefore, the voice processing device 30 generates the language identifier D2 indicating Japanese. The voice INS is a voice giving an instruction to switch the supply source of the image to the LAN source. Therefore, the voice processing device 30 generates the command data D3 representing a command giving an instruction to switch the supply source of the image to the LAN source. In the analysis processing SA110, the voice processing device 30 transmits the language identifier D2 and the command data D3 thus generated, to the display device 10.

In the receiving processing SA120, the processing device 110 functions as the receiving unit 110a. In the receiving processing SA120, the processing device 110 communicates with the voice processing device 30, using the communication device 120, and thus receives the language identifier D2 and the command data D3 transmitted from the voice processing device 30. On receiving the language identifier D2 and the command data D3, the processing device 110 transmits an acknowledgement ACK to the voice processing device 30. On receiving the acknowledgement ACK from the display device 10, the voice processing device 30 transmits voice data D4 representing a response voice OUTS, “understood”, to the voice input-output device 20. On receiving the voice data D4 from the voice processing device 30, the voice input-output device 20 causes the speaker 220 to release the response voice OUTS represented by the voice data D4.

In the first change processing SA130 executed after the receiving processing SA120, the processing device 110 functions as the change unit 110b. In the first change processing SA130, the processing device 110 compares the language identifier D2 received in the receiving processing SA120 with the display language identifier stored in the volatile memory. When the language identifier D2 and the display language identifier stored in the volatile memory differ from each other, the processing device 110 overwrites the display language identifier stored in the volatile memory with the language identifier D2.

In this operation example, the type of the language indicated by the language identifier D2 is Japanese and the type of the language indicated by the display language identifier stored in the volatile memory is English. In this way, since the type of the language indicated by the language identifier D2 and the type of the language indicated by the display language identifier stored in the volatile memory differ from each other, the processing device 110 overwrites the display language identifier stored in the volatile memory with the language identifier D2. Thus, the display language is changed from English to Japanese. The processing device 110 also executes processing corresponding to the command represented by the command data received in the receiving processing SA120. Since the command represented by the command data D3 is a command giving an instruction to switch the supply source of the image to the LAN source, the supply source of the image for the display device 10 is switched to the LAN source, that is, the image supply device connected to the LAN.

It is now assumed that, after the above operations, the user of the display device 10 carries out a voice operation in Japanese giving an instruction to display a user interface screen in order to check the supply source of the image. At the point when this voice operation is carried out, the display language identifier indicating Japanese is stored in the volatile memory of the display device 10. Therefore, the processing device 110 of the display device 10 displays a user interface screen describing information in Japanese. According to the embodiment as described above, the display language can be changed according to the language used for a voice operation of the display device 10, without carrying out a complicated input operation to the input device 140 such as changing the display language each time.

### 2. Modifications

The embodiment can be modified as follows.

(1) In the embodiment, the display device 10 is a projector. However, the display device to which the present disclosure is applicable is not limited to a projector and may be a liquid crystal display. In short, the present disclosure is applicable to any display device that displays a user interface screen describing information using a display language, which is one language of a plurality of types of languages, and that executes processing corresponding to a given command.

(2) The processing device 110 may execute second change processing, described below. In the second change processing, when receiving a second language identifier outputted from the voice processing device 30 after receiving a first language identifier outputted from the voice processing device 30, the processing device 110 compares the second language identifier with the display language identifier stored in the volatile memory. In the second change processing, when the second language identifier and the display language identifier stored in the volatile memory differ from each other, the processing device 110 overwrites the display language identifier stored in the volatile memory with the second language identifier. According to this aspect, for example, every time each of a first user speaking Japanese and a second user speaking English carries out a voice operation of the display device 10, the display language is switched from English to Japanese or from Japanese to English.

The voice processing device 30 need not output a language identifier and command data every time the voice processing device 30 receives voice data from the voice input-output device 20. For example, when the voice processing device 30 sequentially receives first voice data and second voice data from the voice input-output device 20 and a first language identifier generated based on the first voice data and a second language identifier generated based on the second voice data are the same, the voice processing device 30 may omit the output of the second language identifier. This is because when the first language identifier and the second language identifier are the same, the display language changed according to the first language identifier need not be changed according to the second language identifier. According to this aspect, unnecessary data communication between the voice processing device 30 and the display device 10 can be reduced.

(3) A feature value of a voice of a user permitted to carry out a voice operation of the display device 10 may be stored in the voce processing device 30 in advance, and when a feature value calculated based on voice data received from the voice input-output device 20 and the feature value stored in advance coincide with each other, the voice processing device 30 may generate a language identifier and command data based on this voice data. As the feature value of the voice of the user, for example, a spectrum representing a frequency distribution in an audible range may be employed. According to this aspect, a voice operation of the display device 10 by a user who is not permitted to carry out a voice operation can be avoided.

(4) In the embodiment, when the language identifier received from the voice processing device 30 and the display language identifier stored in the volatile memory differ from each other, the processing device 110 overwrites the display language identifier stored in the volatile memory with the language identifier received from the voice processing device 30. However, the processing device 110 may overwrite the display language identifier stored in the non-volatile memory, instead of or in addition to overwriting the display language identifier stored in the volatile memory. In the aspect where only the display language identifier stored in the volatile memory is updated, the user of the display device 10 can return the display language identifier stored in the volatile memory to the display language identifier as of before the update, by an input operation to the input device 140 at any time. The user of the display device 10 may arbitrarily update the display language identifier stored in the volatile memory, by an input operation to the input device 140.

(5) The display device 10 in the embodiment may be manufactured or sold as a single device. While the receiving unit 110a and the change unit 110b in the embodiment are software modules, these units may be hardware modules such as ASICs (application-specific integrated circuits). Even when the display device 10 is formed using the receiving unit 110a and the change unit 110b each formed by hardware, instead of the processing device 110, the same effects as in the embodiment are achieved.

(6) The voice input-output device in the embodiment is a smartphone. However, the voice input-output device 20 may be any device including the microphone 210 and the speaker 220 and having a communication function. The voice input-output device 20 may be a smart speaker. The output of the response voice corresponding to the acknowledgement may be omitted. In the aspect where the output of the response voice is omitted, the speaker 220 may be omitted. In the embodiment, the microphone 210 collecting a voice for a voice operation of the display device 10 is a separate device from the display device 10. However, the microphone 210 may be included in the display device 10. Similarly, the voice processing device 30 may be included in the display device 10.

(7) In the embodiment, the program 152 is already stored in the storage device 150. However, the program 152 may be manufactured or distributed as a single product. As a specific distribution method for the program 152, a method of writing the program 152 in a computer-readable recording medium such as a flash ROM (read-only memory) and distributing the program 152 in this form, or a method of distributing the program 152 by downloading via a telecommunications network such as the internet, may be employed. Causing the processing device included in the display device to operate according to the program 152 distributed by these methods enables the processing device to execute the control method according to the present disclosure.

### 3. Aspects Grasped from at Least One of Embodiment and Modification Examples

The present disclosure is not limited to the above embodiment and modification examples and can be implemented according to various other aspects without departing from the spirit and scope of the present disclosure. For example, the present disclosure can be implemented according to the aspects described below. A technical feature in the embodiment corresponding to a technical feature in the aspects described below can be suitably replaced or combined in order to solve a part or all of the problems of the present disclosure or in order to achieve a part or all of the effects of the present disclosure. The technical feature can be suitably deleted unless described as essential in the specification.

According to an aspect of the present disclosure, the display system 1 includes the display device 10, the microphone 210, and the voice processing device 30. The display device 10 displays a user interface screen describing information using a display language, which is one language of a plurality of types of languages, and also executes processing corresponding to a given command. The microphone 210 collects a voice corresponding to the command and generates voice data representing the collected voice. The voice processing device 30 analyzes the voice data to generate a language identifier indicating a type of a language of the voice represented by the voice data and command data representing the command, and outputs the language identifier and the command data thus generated. The display device 10 includes the processing device 110, and the communication device 120 for communicating with the voice processing device 30. The processing device 110 executes the receiving processing SA120 and the first change processing SA130, described below. In the receiving processing SA120, the processing device 110 receives the language identifier and the command data outputted from the voice processing device 30, using the communication device 120. In the first change processing SA130, the processing device 110 compares the type indicated by the received language identifier with the type of the display language, and changes the display language to the language of the type indicated by the language identifier when the type indicated by the language identifier and the type of the display language differ from each other. In the display system according to this aspect, the display language can be changed according to the language used for a voice operation of the display device 10, without carrying out a complicated input operation such as changing the display language each time.

According to another aspect, in the display system, the processing device 110 of the display device 10 may execute the second change processing, described below. In the second change processing, when receiving a second language identifier outputted from the voice processing device after receiving a first language identifier outputted from the voice processing device 30, the processing device 110 compares the type indicated by the second language identifier with the type of the display language. In the second change processing, when the type indicated by the second language identifier and the type of the display language differ from each other, the processing device 110 changes the display language to the language of the type indicated by the second language identifier. In the display system according to this aspect, the display language changed according to the first language identifier can be further changed according to the second language identifier.

According to still another aspect, in the display system, when the first language identifier and the second language identifier differ from each other, the voice processing device may output the second language identifier. When the first language identifier and the second language identifier are the same, the processing in which the display language changed according to the first language identifier is changed according to the second language identifier is unnecessary processing. According to this aspect, unnecessary data communication between the voice processing device 30 and the display device 10 can be reduced.

According to still another aspect, in the display system, the display device 10 may include the input device 140 accepting an input operation by the user. In this aspect, the processing device 110 of the display device 10 may further execute third change processing in which the display language is changed in response to the input operation to the input device 140. According to this aspect, the display language changed according to the language identifier received from the voice processing device 30 can be further changed in response to the input operation to the input device 140.

According to another aspect of the present disclosure, the display device 10 displays a user interface screen describing information using a display language, which is one language of a plurality of types of languages, and also executes processing corresponding to a given command. The display device 10 includes the communication device 120 and the processing device 110, described below. The communication device 120 is a device for communicating with the voice processing device 30, which analyzes voice data provided from the microphone 210 collecting a voice corresponding to command, thus generates a language identifier indicating a type of a language of the voice and command data representing the command, and outputs the language identifier and the command data thus generated. The processing device 110 executes the receiving processing SA120 and the first change processing SA130, described above. In the display device 10 according to this aspect, the display language can be changed according to the language used for a voice operation of the display device 10, without carrying out a complicated input operation such as changing the display language each time.

According to still another aspect of the present disclosure, the control method for the display device 10 is provided. The display device 10 displays a user interface screen describing information using a display language, which is one language of a plurality of types of languages, and also executes processing corresponding to a given command. The control method includes the generation processing, the receiving processing SA120, and the first change processing SA130, described below. In the receiving processing SA120, the display device 10 receives the language identifier and the command data outputted from the voice processing device 30. In the first change processing SA130, the display device 10 compares the type indicated by the language identifier received in the receiving processing SA120 with the type of the display language, and changes the display language to the language of the type indicated by the language identifier when the type indicated by the language identifier and the type of the display language differ from each other. In the control method according to this aspect, the display language can be changed according to the language used for a voice operation of the display device 10, without carrying out a complicated input operation such as changing the display language each time.

What is claimed is:

1. A display system comprising:
a microphone that collects a voice corresponding to a command and generates voice data representing the voice;
a voice processing device that analyzes the voice data to generate a language identifier indicating a type of a language of the voice and command data representing the command, and outputs the language identifier and the command data; and
a display device including at least one processor that executes
displaying a user interface screen describing information using a display language, the display language is one type of language among a plurality of types of languages,
receiving the language identifier and the command data outputted from the voice processing device,
comparing the type indicated by the language identifier with the type of the display language, and
changing the display language to the language of the type indicated by the language identifier when the type indicated by the language identifier and the type of the display language differ from each other.

2. The display system according to claim 1, wherein
the at least one processor further executes
comparing a type indicated by second language identifier with the type of the display language, when receiving the second language identifier from the voice processing device after receiving a first language identifier, and
changing the display language to the language of the type indicated by the second language identifier, when the type indicated by the second language identifier and the type of the display language differ from each other.

3. The display system according to claim 2, wherein
the voice processing device outputs the second language identifier when the first language identifier and the second language identifier differ from each other.

4. The display system according to claim 1, wherein
the display device further includes an input device accepting an input operation, and
the at least one processor further executes
changing the display language when a command which instructs to change the display language is inputted by the input operation to the input device.

5. A display device comprising:
a communication device; and
at least one processor programmed to execute
displaying a user interface screen describing information using a display language, the display language is one type of language among a plurality of types of languages,
receiving a language identifier indicating a type of a language of a voice and command data representing a command corresponding to the voice, using the communication device,
comparing the type indicated by the language identifier with the type of the display language, and
changing the display language to the language of the type indicated by the language identifier when the type indicated by the language identifier and the type of the display language differ from each other.

6. A control method for a display device, the control method comprising:
displaying a user interface screen describing information using a display language, the display language is one type of language among a plurality of types of languages;
receiving a language identifier indicating a type of a language of a voice and command data representing a command corresponding to the voice, from a voice processing device;
comparing the type indicated by the language identifier with the type of the display language; and
changing the display language to the language of the type indicated by the language identifier when the type indicated by the language identifier and the type of the display language differ from each other.
